(19) United States
(12) Patent Application Publication
(10) Pub. No.: US 2024/0301117 A1
(43) Pub. Date: Sep. 12, 2024

(54) HIGH DENSITY POLYETHYLENE COMPOSITIONS, METHOD OF PRODUCING THE SAME, CLOSURE DEVICES MADE THEREFROM, AND METHOD OF MAKING SUCH CLOSURE DEVICES

(71) Applicant: Dow Global Technologies LLC, Midland, MI (US)

(72) Inventors: Keran Lu, Pearland, TX (US); Stephanie M. Whited, South Charleston, WV (US); Mridula Kapur, Lake Jackson, TX (US)

(21) Appl. No.: 18/264,596

(22) PCT Filed: May 13, 2022
(86) PCT No.: PCT/US2022/029150

§ 371 Date: Aug. 8, 2023

Related U.S. Application Data
(60) Provisional application No. 63/190,524, filed on May 19, 2021.

(51) Int. Cl. C08F 297/08

(52) U.S. Cl. CPC C08F 297/083

(57) ABSTRACT

Bimodal high density polyethylene compositions can achieve an improved balance of stress crack resistance and processability by selecting the higher molecular weight and lower molecular weight components such that (1) the lower molecular weight component has a relatively high complementary density, which is a calculated property shown by the formula below, and (2) the higher molecular weight component of the composition has a moderately-low density and narrow molecular weight distribution. This combination of properties provides improved balance of stress crack resistance and processability without having to modify the properties of the higher molecular weight component.

### FIELD OF INVENTION

The instant invention relates to high density polyethylene compositions and molded articles made from them.

### BACKGROUND OF THE INVENTION

Polyethylene resins can be molded into useful articles using molding processes such as compression molding and injection molding. Among the molded articles made this way, beverage containers for carbonated soft drinks and their closures are a common product.

In compression molding processes, a two-piece mold provides a cavity having the shape of a desired molded article. The mold is heated, and an appropriate amount of molten molding compound from an extruder is loaded into the lower half of the mold. The two parts of the mold are brought together under pressure. The molding compound, softened by heat, is thereby welded into a continuous mass having the shape of the cavity. The continuous mass may be hardened via chilling under pressure in the mold.

In injection molding processes, molding compound is fed into an extruder via a hopper. The extruder conveys, heats, melts, and pressurizes the molding compound to form a molten stream. The molten stream is forced out of the extruder through a nozzle into a relatively cool mold, held closed under pressure, thereby filling the mold. The melt cools and hardens until fully set-up. The mold then opens, and the molded part is removed.

The polyethylene resins used for molding articles desirably have:
high tensile and/or flexural modulus, so that the quantity of resin used can be minimized, reducing weight of the finished article. High modulus is often associated with a higher density resin.
low viscosity when melted, so that they can be injection molded into complex shapes quickly and easily without voids. Low melt viscosity, particularly under shear conditions that occur in molding, is a key element in the processability of the resin.
high resistance to environmental stress cracking, so that finished articles do not crack and leak during storage and handling.

However, polyethylene resins with higher density and/or lower melt viscosity often also have lower environmental stress crack resistance. The search for resins that can improve the balance of these properties is described—for example—in the following patent references: U.S. Pat. Nos. 7,153,909B2; 7,396,878 B2; 8,697,806B2; 9,056,970B2; 9,175,111B2; 9,371,442 B2; 9,988,473B2; WO 2013/040676 A1; and WO 2014/089670 A1.

Narrow molecular weight distribution catalysts have been demonstrated to produce excellent bimodal injection molding high density polyethylene (HDPE) grades. Research efforts have focused on tailoring the properties of these bimodal resins to achieve a good balance of processability, physical strength, and stress crack resistance. It is widely known that stress crack resistance of a multicomponent composition can be improved by increasing the molecular weight of the higher molecular weight fraction or increasing the comonomer content of the higher molecular weight fraction (which decreases its density). However, adjusting the higher molecular weight fraction in this way has consequences of higher viscosity and/or lower stiffness. Oftentimes, another quantity like the weight fraction of the higher molecular weight must be adjusted to compensate. For example, WO 2013/040676 A1 teaches that a useful bimodal composition can be achieved by (1) concentrating short-chain branching (comonomer content) within the higher molecular weight fraction and by (2) limiting the density of the lower molecular weight component to less than 0.967 g/cm³.

It is desirable to further improve the balance of density, processability, and/or environmental stress crack resistance in high density polyethylene compositions.

### SUMMARY OF THE INVENTION

We have found that an improved balance of stress crack resistance and processability can be achieved in a bimodal high density polyethylene composition by selecting the properties of the resin components for the combination of (1) a higher complementary density of the lower molecular weight component and (2) a lower density and narrow molecular weight distribution for the higher molecular weight component. This combination can achieve improved balance of stress crack resistance and processability without having to modify the properties of the higher molecular weight fraction.

The present invention includes high density polyethylene compositions, molded articles made therefrom, and methods of making such molded articles.

The high density polyethylene composition according to the present invention comprises:
a) 40 to 65 weight percent of a higher molecular weight ethylene copolymer component (HMW Component) having a flow index (I₂₁) in the range of 1 to 10 g/10 min and a density of from 0.920 to 0.935 g/cm³ and a molecular weight distribution (M_{w}/Mₙ) of less than 4.0, and
b) 35 to 60 weight percent of a lower molecular weight ethylene homopolymer or copolymer component (LMW Component) having a complementary density (CD) of greater than 0.976 g/cm³ according to the following formula:

$$CD = \frac{LMW Component Weight Percent / 100}{( \frac{1}{Overall Density} ) - ( \frac{HMW Component Weight Percent / 100}{HMW Component Density} )}$$

wherein weight percentages are based on percentages of the combined weight of the higher molecular weight and lower molecular weight polyethylene components only and wherein the high density polyethylene composition has overall:
i. a melt index (I₂) of less than or equal to 4.5 g/10 min, and
ii. a density of 0.950 to 0.962 g/cm³.

A molded article according to the present invention comprises a high density polyethylene composition described above.

The method of making a molded article according to the present invention comprises the steps of: (1) providing a high density polyethylene composition as described above; and (2) compression molding, blow molding, or injection molding the high density polyethylene composition thereby forming the molded article.

### DETAILED DESCRIPTION OF THE INVENTION

The high density polyethylene composition of the instant invention is bimodal, meaning that it comprises a higher molecular weight (HMW) component, and a lower molecular weight (LMW) component. “Higher molecular weight” means that the HMW Component is calculated to have higher molecular weight than the LMW Component, and “lower molecular weight” means that the LMW Component is calculated to have a lower molecular weight than the HMW Component.

### Higher Molecular Weight Component

The higher molecular weight component is a copolymer of ethylene and one or more alpha-olefin comonomers. Content of comonomer can be measured based on the number of short-chain branches per 1000 carbon atoms, as described in the Test Methods below. In some embodiments of the inventive composition, the HMW Component can contain at least 1.0 short-chain branches per 1000 carbon atoms, or at least 1.3 short-chain branches per 1000 carbon atom, or at least 1.6 short-chain branches per 1000 carbon atom, and can contain at most 10 short-chain branches per 1000 carbon atoms, or at most 4.5 short-chain branches per 1000 carbon atoms.

The alpha-olefin comonomers typically have at most 20 carbon atoms. For example, the alpha-olefin comonomers can have 3 to 10 carbon atoms or 4 to 8 carbon atoms. Exemplary alpha-olefin comonomers include, but are not limited to, propylene, 1-butene, 1-pentene, 1-hexene, 1-heptene, 1-octene, 1-nonene, 1-decene, and 4-methyl-1-pentene. In some embodiments, the alpha-olefin comonomers may be selected from the group consisting of 1-butene, 1-hexene, and 1-octene, or from the group consisting of 1-butene and 1-hexene.

The HMW Component has a density in the range of 0.920 to 0.935 g/cm³. In some embodiments, the density of the HMW Component can be at least 0.923 g/cm³, or at least 0.925 g/cm³, or at least 0.928 g/cm³, and can be at most 0.934 g/cm³. Density and other properties of the HMW Component can be measured by taking a sample of the HMW Component before addition or polymerization of the lower molecular weight component.

The HMW Component has a flow index (I₂₁) in the range of 1 to 10 g/10 minutes. In some embodiments, the flow index (I₂₁) of the HMW Component can be at least 2 g/10 minutes, or at least 3 g/10 minutes, or at least 4 g/10 minutes, and can be at most 9 g/10 minutes, or at most 8 g/10 minutes, or at most 7 g/10 minutes.

In some embodiments, the number average molecular weight (Mₙ) of the HMW Component can be at least 25,000 g/mol, or at least 40,000 g/mol, or at least 55,000 g/mol, and can be at most 80,000 g/mol, or at most 74,000 g/mol, or at most 68,000 g/mol.

In some embodiments, the weight average molecular weight (M_{w}) of the HMW Component can be at least 90,000 g/mol, or at least 110,000 g/mol, or at least 140,000 g/mol, and can be at most 280,000 g/mol, or at most 250,000 g/mol, or at most 220,000 g/mol.

In some embodiments, the molecular weight distribution (M_{w}/Mₙ) of the HMW Component can be at least 2.3, or at least 2.5, or at least 2.7, and can be at most 3.8, or at most 3.6, or at most 3.3.

The HMW Component is in some embodiments substantially free of long chain branching. “Substantially free of long chain branching”, as used herein, refers to an ethylene polymer substituted with less than 0.1 long chain branches per 1000 carbons or less than 0.01 long chain branches per 1000 carbons. The presence of long chain branches can be determined by gel permeation chromatography coupled with low angle laser light scattering detector (GPC-LALLS) and gel permeation chromatography coupled with a differential viscometer detector (GPC-DV) or by NMR.

The HMW Component makes up 40 weight percent to 65 weight percent of the polyethylene resins in the composition. In some embodiments, the HMW Component can make up at least 41 weight percent of the polyethylene resins in the composition, or at least 42 weight percent, or at least 43 weight percent, and can make up at most 60 weight percent of the polyethylene resins in the composition, or at most 58 weight percent, or at most 54 weight percent, or at most 52 weight percent.

### Lower Molecular Weight Component

The high density polyethylene composition of this invention also comprises a lower molecular weight polyethylene component (LMW Component).

It is useful to characterize the LMW Component based on its “complementary density”. Complementary density is a calculated density using the following formula:

$$CD = \frac{LMW Component Weight Percent / 100}{( \frac{1}{Overall Density} ) - ( \frac{HMW Component Weight Percent / 100}{HMW Component Density} )}$$

wherein

| | |
|---|---|
| CD is: | The complementary density of the LMW Component. |
| Overall Density is: | The density of the overall composition containing both the HMW |
| | Component and the LMW Component, as measured according to the |
| | Test Methods. |
| HMW Component | The weight of HMW Component as a percentage of the combined |
| Weight Percent is: | weight of the HMW Component and the LMW Component. |
| HMW Component | The density of the HMW Component, as measured according to the |
| Density is: | Test Methods. |
| LMW Component | The weight of LMW Component as a percentage of the combined |
| Weight Percent is: | weight of the HMW Component and the LMW Component. |

The complementary density can be measured when the LMW Component is produced in a second or later reactor of a multi-reactor system, because it does not require a separate LMW sample. Further, complementary density takes into account the effect of chain packing interactions and component mixing effectiveness of the composition. Complementary density can be increased relative to the ASTM-measured density through improved mixing of components (through well-known methods), reduced thermal quenching rates of products during crystallization to promote improved chain packing, reducing comonomer incorporated into the LMW Component, and decreasing the molecular weight of the LMW Component.

Contrary to earlier work, in which the maximum density of the LMW Component was restricted, we have found that a higher complementary density of the LMW Component (in combination with an HMW Component that has moderately-low density and a narrow molecular weight distribution), results in improved combinations of stress crack resistance and processability.

The LMW Component has a complementary density (CD) of greater than 0.976 g/cm³. In some embodiments, the complementary density of the LMW Component can be at least 0.977 g/cm³ or at least 0.979 g/cm³. In some embodiments, the complementary density of the LMW Component can be at most 0.990 g/cm³, or at most 0.988 g/cm³, or at most 0.985 g/cm³.

In certain embodiments, the LMW Component is a polyethylene homopolymer or a copolymer having a relatively low level of comonomer, which can contribute to increasing the complementary density of the LMW Component. When the LMW Component is a polyethylene homopolymer, at least 99.8 mole percent of repeating units are derived from ethylene.

When the LMW Component is a polyethylene copolymer, the description of the comonomers in the copolymer is the same as the description for the HMW Component. For example, the alpha-olefin comonomers of the LMW Component can have at most 20 carbon atoms. In some embodiments, the alpha-olefin comonomers can have 3 to 10 carbon atoms or 4 to 8 carbon atoms. Exemplary alpha-olefin comonomers include, but are not limited to, propylene, 1-butene, 1-pentene, 1-hexene, 1-heptene, 1-octene, 1-nonene, 1-decene, and 4-methyl-1-pentene. The alpha-olefin comonomers may optionally be selected from the group consisting of 1-butene, 1-hexene, and 1-octene, or from the group consisting of 1-butene and 1-hexene. However, in the LMW Component in some embodiments, the ethylene content can be at least 99.5 mole percent of repeating units are derived from ethylene, or at least 99.7 mole percent, or at least 99.8 mole percent.

When the LMW Component is made in the second stage of a two-stage polymerization, it is difficult to obtain a separate sample to directly measure density and melt index of the LMW Component. However, the density and melt index of the LMW Component can be estimated using models developed by producing a series of the LMW Component alone (without the first stage reaction) using the same equipment, reagents, and reaction conditions, and measuring the density and melt index of the separately-produced resins. In the current high density polyethylene compositions, the LMW Component according to some embodiments can have an estimated melt index (I₂) of at least 700 g/10 minutes, or at least 1000 g/10 min., or at least 1200 g/10 min., and can have an estimated melt index (I₂) of at most 4000 g/10 minutes, or at most 3000 g/10 min., or at most 2500 g/10 min.

In some embodiments, the weight average molecular weight (M_{w}) of the LMW Component can be at least 13,000, or at least 14,000, or at least 15,000, and can be at most 22,000, or at most 20,000, or at most 19,000.

In some embodiments, the LMW Component is substantially free of any long chain branching. “Substantially free of any long chain branching”, as used herein, refers to an ethylene polymer substituted with less than 0.1 long chain branches per 1000 carbons or less than 0.01 long chain branches per 1000 carbons. The presence of long chain branches can be determined according to the methods known in the art, as described above.

The LMW Component makes up 35 weight percent to 60 weight percent of the polyethylene resins in the composition. In some embodiments, the LMW Component can make up at least 40 weight percent of the polyethylene resins in the composition, or at least 42 weight percent, or at least 46 weight percent, or at least 48 weight percent, and can make up at most 59 weight percent of the polyethylene resins in the composition, or at most 58 weight percent, or at most 57 weight percent.

### Properties of the Overall Composition

The high density polyethylene composition (having both the HMW Component and the LMW Component) has a density in the range of 0.950 to 0.962 g/cm³. In some embodiments, the density of the high density polyethylene composition can be at least 0.952 g/cm³, or at least 0.953 g/cm³, or at least 0.954 g/cm³, and can be at most 0.960 g/cm³, or at most 0.959 g/cm³, or at most 0.958 g/cm³.

The high density polyethylene composition has a melt index (I₂) of less than 4.5 g/10 minutes. In some embodiments, the melt index (I₂) can be at most 4.2 g/10 min., or at most 4.0 g/10 min., or at most 3.8 g/10 min., or at most 3.3 g/10 min., or at most 3.2 g/10 min. In some embodiments, the melt index (I₂) can be at least 0.3 g/10 min., or at least 0.7 g/10 min., or at least 1.3 g/10 min., or at least 1.5 g/10 min., or at least 2.1 g/10 min.

In some embodiments, the flow index (I₂₁) of the high density polyethylene composition can be at least 40 g/10 min., or at least 60 g/10 min., or at least 75 g/10 min., and can be at most 300 g/10 minutes, or at most 250 g/10 minutes, or at most 220 g/10 minutes.

In some embodiments, the number average molecular weight (Mₙ) of the high density polyethylene composition can be at least 4,000 g/mol, or at least 5,000 g/mol, or at least 6,000 g/mol, and can be at most 25,000 g/mol, or at most 12,000 g/mol, or at most 10,000 g/mol.

In some embodiments, the weight average molecular weight (M_{w}) of the high density polyethylene composition can be at least 60,000 g/mol, or at least 75,000 g/mol, or at least 90,000 g/mol, and can be at most 180,000 g/mol, or at most 150,000 g/mol, or at most 125,000 g/mol.

In some embodiments, the high density polyethylene composition can have a molecular weight distribution (M_{w}/Mₙ) greater than 7. In some embodiments, the molecular weight distribution can be at least 13.5, or at least 14, or at least 15. In some embodiments, the molecular weight distribution can be at most 25, or at most 20, or at most 18, or at most 17.

In some embodiments, the high density polyethylene composition has a higher environmental stress crack resistance (F₅₀) as compared to other polyethylene compositions with similar melt index. For example, the environmental stress crack resistance (F₅₀) (measured according to ASTM D-1693, condition B at 50° C., and using a 10 percent Tergitol NP-9 aqueous solution) can be at least 100 hours, or at least 200 hours, or at least 300 hours, or at least 400 hours, or at least 500 hours, or at least 800 hours. On the other hand, in some embodiments the environmental stress crack resistance (F₅₀) (measured according to ASTM D-1693, condition B at 50° C., and using a 10 percent Tergitol NP-9 aqueous solution) may be kept lower in order to achieve better processability. For example, the environmental stress crack resistance (F₅₀) (measured according to ASTM D-1693, condition B at 50° C., and using a 10 percent Tergitol NP-9 aqueous solution) may optionally be at most 1200 hours, at most 1000 hours, or at most 500 hours. For example, some embodiments may have an environmental stress crack resistance (F₅₀) from 200 hours to 500 hours, and others may have an environmental stress crack resistance (F₅₀) from 500 hours to 900 hours.

The melt index (I₂) of a polyethylene composition is one of the properties that is frequently related to the environmental stress crack resistance of the composition. In the inventive compositions, the environmental stress crack resistance (F₅₀) (measured as described above) can satisfy the following formula:

$${F}_{50} \geq ( 400 hr - ( MI ) * 78 [ ( 10 - min * hr ) / g ] )$$

wherein F₅₀ is the environmental stress crack resistance in hours, and MI is the melt index (I₂) of the polyethylene composition in g/10 minutes. The F₅₀ in this formula may optionally have the same minimum values listed in the preceding paragraph.

The high density polyethylene composition may further include additional components such as other polymers, and/or additives. Such additives include, but are not limited to, antistatic agents, color enhancers, dyes, lubricants, fillers, pigments, primary antioxidants, secondary antioxidants, processing aids, UV stabilizers, nucleators, and combinations thereof. In some embodiments, the high density polyethylene composition compromises less than 10 weight percent of one or more additives, based on the weight of the high density polyethylene composition. All individual values and subranges from less than 10 weight percent are included herein and disclosed herein; for example, the high density polyethylene composition may comprise less than 5 percent by the combined weight of one or more additives, based on the weight of the high density polyethylene composition; or in the alternative, the high density polyethylene composition may comprise less than 1 percent by the combined weight of one or more additives, based on the weight of the high density polyethylene composition; or in another alternative, the high density polyethylene composition may compromise less than 0.5 percent by the combined weight of one or more additives, based on the weight of the high density polyethylene composition. Antioxidants, such as IRGAFOS 168 and IRGANOX 1010, are commonly used to protect the composition from thermal and/or oxidative degradation. IRGANOX 1010 is pentaerythritol tetrakis[3-[3,5-di-tert-butyl-4-hydroxyphenyl]propionate, which is commercially available from Ciba Geigy Inc. IRGAFOS 168 is tris (2,4-di-tert-butylphenyl) phosphite, which is commercially available from Ciba Geigy Inc.

The inventive high density polyethylene composition may further be blended with other polymers. Such other polymers are generally known to a person of ordinary skill in the art. Blends comprising the inventive high density polyethylene composition are formed via any conventional methods. For example, the selected polymers are melt blended via a single or twin screw extruder, or a mixer, e.g. a Kobe LCM or KCM mixer, a Banbury mixer, a Haake mixer, a Brabender internal mixer.

In some embodiments, blends containing the inventive high density polyethylene composition comprise at least 40 percent by weight of the inventive high density polyethylene composition, based on the total weight of the blend. All individual values and subranges in the range of at least 40 weight percent are included herein and disclosed herein; for example, the blend can comprise at least 50 percent by weight of the inventive high density polyethylene composition, based on the total weight of the blend; or in the alternative, the blend can comprise at least 60 percent by weight of the inventive high density polyethylene composition, based on the total weight of the blend; or in the alternative, the blend can comprise at least 70 percent by weight of the inventive high density polyethylene composition, based on the total weight of the blend; or in the alternative, the blend can comprise at least 80 percent by weight of the inventive high density polyethylene composition, based on the total weight of the blend; or in the alternative, the blend can comprise at least 90 percent by weight of the inventive high density polyethylene composition, based on the total weight of the blend; or in the alternative, the blend can comprise at least 95 percent by weight of the inventive high density polyethylene composition, based on the total weight of the blend; or in the alternative, the blend can comprise at least 99 percent by weight of the inventive high density polyethylene composition, based on the total weight of the blend.

In some embodiments, the composition contains less than 10 weight percent of polyethylene homopolymers and copolymers other than the HMW Component and the LMW Component, or less than 5 percent, or less than 2 percent, or less than 1 percent.

### Process to Produce the Composition

Compositions of the present invention can be made by known means such as by polymerization of ethylene and comonomers using metallocene catalysts in a dual-stage polymerization system having two polymerization reactors in series, wherein one component is mostly produced in the first reactor and the other component is mostly produced in the second reactor. Suitable dual stage polymerization systems are well-known and described in numerous patent publications, such as US2007/0043177A1, US2010/0084363A1, U.S. Pat. No. 9,988,473B2, EP0,503,791A1 and EP0,533,452A1.

Examples of dual sequential polymerization systems include, but are not limited to, gas phase polymerization/gas phase polymerization; gas phase polymerization/liquid phase polymerization; liquid phase polymerization/gas phase polymerization; liquid phase polymerization/liquid phase polymerization; slurry phase polymerization/slurry phase polymerization; liquid phase polymerization/slurry phase polymerization; slurry phase polymerization/liquid phase polymerization; slurry phase polymerization/gas phase polymerization; and gas phase polymerization/slurry phase polymerization.

In production, a dual sequential polymerization system connected in series, as described above, may be used. The HMW Component can be produced in the first stage of the dual sequential polymerization system, and the LMW Component, i.e. the low molecular weight ethylene polymer, can be prepared in the second stage of the dual sequential polymerization system. Alternatively, the LMW Component, i.e. the low molecular weight ethylene polymer, can be made in the first stage of the dual sequential polymerization system, and the HMW Component, i.e. the high molecular weight ethylene polymer, can be made in the second stage of the dual sequential polymerization system.

In one embodiment, the HMW Component is made primarily in the first stage reaction, and the LMW Component is made primarily in the second stage reaction. Ethylene and one or more alpha-olefin comonomers are continuously fed into a first reactor with a catalyst system including a cocatalyst, hydrogen, and optionally inert gases and/or liquids, under conditions suitable to polymerize the ethylene and comonomers to produce the HMW Component. Examples of suitable inert gases and liquids include nitrogen, isopentane or hexane. The HMW Component/active catalyst mixture is then continuously transferred from the first reactor to a second reactor, such as in batches. Ethylene, hydrogen, cocatalyst, and optionally comonomer, inert gases and/or liquids are continuously fed to the second reactor, and the reactor is maintained under conditions suitable to produce the LMW Component. The inventive high density polyethylene composition is removed from the second reactor. One exemplary mode is to take batch quantities of HMW Component from the first reactor, and transfer these to the second reactor using the differential pressure generated by a recycled gas compression system.

One catalyst that is suitable to make the compositions is a hafnium-containing metallocene catalyst system. Useful examples include silica supported hafnium transition metal metallocene methylalumoxane catalysts systems, such as those described in the following US Patents: U.S. Pat. Nos. 6,242,545 and 6,248,845 and spray-dried hafnium transition metal metallocene methylalumoxane catalysts systems such as those described in U.S. Pat. No. 8,497,330. Spray-dried hafnium or zirconium transition metal metallocene catalyst systems are particularly suitable.

A suitable hafnium-containing catalyst system can be made by contacting bis(n-propylcyclopentadienyl)hafnium X₂ complex, wherein each X independently is Cl, methyl, 2,2-dimethylpropyl-CH₂Si(CH₃)₃, or benzyl (“bis(n-propylcyclopentadienyl)hafnium X₂”), with an activator. The activator may comprise a methylaluminoxane (MAO). The catalyst is available from The Dow Chemical Company, Midland, Michigan, USA or may be made by methods described in the art. An illustrative method is described later for making a spray-dried catalyst system.

The polymerization catalyst may be fed into a polymerization reactor(s) in “dry mode” or “wet mode”. The dry mode is a dry powder or granules. The wet mode is a suspension in an inert liquid such as mineral oil or the (C₅-C₂₀)alkane(s). The bis(n-propylcyclopentadienyl)hafnium X₂ may be unsupported when contacted with an activator, which may be the same or different for different catalysts. Alternatively, the bis(n-propylcyclopentadienyl)hafnium X₂ may be disposed by spray-drying onto a solid support material prior to being contacted with the activator(s). The solid support material may be uncalcined or calcined prior to being contacted with the catalysts. The solid support material may be a hydrophobic fumed silica (e.g., a fumed silica treated with dimethyldichlorosilane). The unsupported or supported catalyst system may be in the form of a powdery, free-flowing particulate solid.

Support material. The support material may optionally be an inorganic oxide material. The terms “support” and “support material” are the same as used herein and refer to a porous inorganic substance or organic substance. In some embodiments, desirable support materials may be inorganic oxides that include Group 2, 3, 4, 5, 13 or 14 oxides, alternatively Group 13 or 14 atoms. Examples of inorganic oxide-type support materials are silica, alumina, titania, zirconia, thoria, and mixtures of any two or more of such inorganic oxides. Examples of such mixtures are silica-chromium, silica-alumina, and silica-titania.

The inorganic oxide support material is porous and has variable surface area, pore volume, and average particle size. In some embodiments, the surface area is from 50 to 1000 square meter per gram (m²/g) and the average particle size is from 20 to 300 micrometers (μm). Alternatively, the pore volume is from 0.5 to 6.0 cubic centimeters per gram (cm³/g) and the surface area is from 200 to 600 m²/g. Alternatively, the pore volume is from 1.1 to 1.8 cm³/g and the surface area is from 245 to 375 m²/g. Alternatively, the pore volume is from 2.4 to 3.7 cm³/g and the surface area is from 410 to 620 m²/g. Alternatively, the pore volume is from 0.9 to 1.4 cm³/g and the surface area is from 390 to 590 m²/g. Each of the above properties are measured using conventional techniques known in the art.

The support material may comprise silica, alternatively amorphous silica (not quartz), alternatively a high surface area amorphous silica (e.g., from 500 to 1000 m²/g). Such silicas are commercially available from several sources including the Davison Chemical Division of W.R. Grace and Company (e.g., Davison 952 and Davison 955 products), and PQ Corporation (e.g., ES70 product). The silica may be in the form of spherical particles, which are obtained by a spray-drying process. Alternatively, MS3050 product is a silica from PQ Corporation that is not spray-dried. As procured, these silicas are not calcined (i.e., not dehydrated). Silica that is calcined prior to purchase may also be used as the support material.

Prior to being contacted with a catalyst, the support material may be pretreated by heating the support material in air to give a calcined support material. The pretreating comprises heating the support material at a peak temperature from 350° to 850° C., alternatively from 400° to 800° C., alternatively from 400° to 700° C., alternatively from 500° to 650° C. and for a time period from 2 to 24 hours, alternatively from 4 to 16 hours, alternatively from 8 to 12 hours, alternatively from 1 to 4 hours, thereby making a calcined support material. The support material may be a calcined support material.

Each polymerization catalyst is activated by contacting it with an activator. The activator for each polymerization catalyst may be the same or different as another and independently may be a Lewis acid, a non-coordinating ionic activator, or an ionizing activator, or a Lewis base, an alkylaluminum, or an alkylaluminoxane (alkylalumoxane). The alkylaluminum may be a trialkylaluminum, alkylaluminum halide, or alkylaluminum alkoxide (diethylaluminum ethoxide). The trialkylaluminum may be trimethylaluminum, triethylaluminum (“TEAl”), tripropylaluminum, or tris(2-methylpropyl)aluminum. The alkylaluminum halide may be diethylaluminum chloride. The alkylaluminum alkoxide may be diethylaluminum ethoxide. The alkylaluminoxane may be a methylaluminoxane (MAO), ethylaluminoxane, 2-methylpropyl-aluminoxane, or a modified methylaluminoxane (MMAO). Each alkyl of the alkylaluminum or alkylaluminoxane independently may be a (C₁-C₇)alkyl, alternatively a (C₁-C₆)alkyl, alternatively a (C₁-C₄)alkyl. The molar ratio of activator's metal (Al) to a particular catalyst compound's metal (catalytic metal, e.g., Hf) may be 1000:1 to 0.5:1, alternatively 300:1 to 1:1, alternatively 150:1 to 1:1. Suitable activators are commercially available.

Once the activator and the bis(n-propylcyclopentadienyl)hafnium X₂ contact each other, the catalyst system is activated, and activator species may be made in situ. The activator species may have a different structure or composition than the catalyst and activator from which it is derived and may be a byproduct of the activation of the catalyst or may be a derivative of the byproduct. The activator species may be a derivative of the Lewis acid, non-coordinating ionic activator, ionizing activator, Lewis base, alkylaluminum, or alkylaluminoxane, respectively.

Each contacting step between activator and catalyst independently may be done either in a separate vessel outside a polymerization reactor or in a feed line to the reactor.

The temperature in each reactor is generally 70° C. to 110° C. The pressure is generally 1400 kPa to 3200 kPa.

The molecular weight of each component is controlled by the ratio of hydrogen to ethylene in the reactor. In production of the HMW Component, the molar ratio of hydrogen to ethylene is generally between 0 and 0.0015. In production of the LMW Component, the ratio of hydrogen to ethylene is generally between 0.001 and 0.010. It is well-known how to experimentally determine the best ratios to achieve the desired molecular weight for each component, based on the equipment and reactants being used.

After the high density polyethylene composition is withdrawn from the polymerization reaction system, it is generally transferred to a purge bin under inert atmosphere conditions. Subsequently, the residual hydrocarbons are removed, and moisture is introduced to reduce any residual aluminum alkyls and any residual catalysts before the inventive high density polyethylene composition is exposed to oxygen. The high density polyethylene composition may optionally be transferred to an extruder to be pelletized. Such pelletization techniques are generally known.

The high density polyethylene composition may optionally be melt screened in the pelletizing process. Subsequent to the melting process in the extruder, the molten composition is passed through one or more active screens (positioned in series of more than one) with each active screen having a micron retention size of from 2 to 400 (2 to 4×10⁻⁵ m), or 2 to 300 (2 to 3×10⁻⁵ m), or 2 to 70 (2 to 7×10⁻⁶ m), at a mass flux of 5 to 100 lb/hr/in² (1.0 to 20 kg/s/m²). Such further melt screening is disclosed in U.S. Pat. No. 6,485,662.

Additives described above, such as antistatic agents, color enhancers, dyes, lubricants, fillers, pigments, primary antioxidants, secondary antioxidants, processing aids, UV stabilizers, nucleators, and combinations thereof, are generally added during the pelletization process.

### Methods to Mold the Composition and Molded Articles

The high density polyethylene composition may be used to manufacture shaped articles. Such articles may include, but are not limited to, closure devices such as bottle caps, wire cable jacketing, and conduit pipes Suitable conversion techniques to make shaped articles include, but are not limited to, wire coating, pipe extrusion, blow molding, coextrusion blow molding, injection molding, injection blow molding, injection stretch blow molding, compression molding, extrusion, pultrusion, and calendering. Such techniques are generally well known. Examples of suitable conversion techniques include wire coating, pipe extrusion, injection blow molding, compression molding, and injection molding. Out of these techniques, injection molding and compression molding may be particularly suitable in some embodiments. These techniques are well-known and are generally described in the Background of this Application.

Closure devices such as bottle caps including the inventive high density polyethylene composition exhibit improved processability while maintaining satisfactory environmental stress crack resistance. Such bottle caps are adapted to withstand the pressure of carbonated drinks. Such bottle caps further facilitate closure, and sealing of a bottle, i.e. optimum torque provided by a machine to screw the cap on the bottle, or unsealing a bottle, i.e. optimum torque provide by a person to unscrew the cap.

### EXAMPLES

The following examples are provided in order to further illustrate the invention and are not to be construed as limiting.

### Materials:

Antioxidant 1: Tris(2,4-di-tert-butylphenyl)phosphite obtained as IRGAFOS 168 from BASF.
Catalyst: bis(n-propylcyclopentadienyl)hafnium dimethyl. CAS no. 255885-01-9. The catalyst can be made according to Example 7 of U.S. Pat. No. 6,175,027 B1, except HfCl₄ is used in place of ZrCl₄ to give bis(n-propylcyclopentadienyl)hafnium dichloride, and then reacting same with methyl magnesium chloride to give bis(n-propylcyclopentadienyl)hafnium dimethyl. The catalyst is also commercially available from BOC Sciences, a brand of BOCSCI Inc., Shirley, New York, USA and from Boulder Scientific.
Continuity Additive: CA-300 from Univation Technologies, LLC, Houston, Texas, USA.
Activator: methyl aluminoxane (MAO).
Ethylene (“C₂”): CH₂═CH₂.
1-Hexene (“C6”): CH₂═CH(CH₂)₃CH₃
ICA: a mixture consisting essentially of at least 95%, alternatively at least 98% of 2-methylbutane (isopentane, CH₃(CH₂)₂CH(CH₃)₂) and minor constituents that at least include pentane (CH₃(CH₂)₃CH₃).
Molecular hydrogen gas: H₂.
Mineral oil: Sonneborn HYDROBRITE 380 PO White.

### Preparation of Spray-Dried Catalyst System 1 (sd-Cat-1): Bis(propylcyclopentadienyl)hafnium dimethyl Spray-Dried on Silica

A batch of the catalyst system (sd-Cat-1) is prepared as a dry powder according to U.S. Pat. No. 8,497,330 B2, column 22, lines 48 to 67.

Another batch of the sd-Cat-1 is prepared as follows: Use a Büchi B-290 mini spray-drier contained in a nitrogen atmosphere glovebox. Set the spray drier temperature at 165° C. and the outlet temperature at 60° to 70° C. Mix fumed silica (Cabosil TS-610, 3.2 g), MAO in toluene (10 wt %, 21 g), and bis(propylcyclopentadienyl)hafnium dimethyl (0.11 g) in toluene (72 g). Introduce the resulting mixture into an atomizing device, producing droplets that are then contacted with a hot nitrogen gas stream to evaporate the liquid therefrom, thereby making a powder. Separate the powder from the gas mixture in a cyclone separator, and collect the sd-Cat-1 as a powder (3.81 g) in a cone can.

The two batches are deemed to be substantially equivalent and are used interchangeably. Part of the sd-Cat-1 is kept as a dry powder, and part is mixed as a slurry of 18% solids in mineral oil.

### Preparation of Inventive Examples 1 Through 6 (IE1-IE6) and Comparative Example 1 (CE 1)

Feed Catalyst listed in Table A to a fluidized-bed gas phase polymerization dual reactor system comprising two Pilot FB-GPP Reactors (first reactor and second reactor) comprising beds of polyethylene granules. After reaching equilibrium in the first reactor, polymerize ethylene (C₂) and 1-hexene (C₆). Initiate polymerization in the first reactor by continuously feeding the catalyst powder, ethylene, 1-hexene and hydrogen (H₂) into the fluidized bed of polyethylene granules, while also feeding continuity additive CA-300 as a 20 wt % solution in mineral oil.

Withdraw the HMW PE component from the first reactor as a unimodal polyethylene polymer that contains active catalyst. Keep a sample of the HMW PE constituent for testing and transfer the remaining material to the second reactor using second reactor gas as a transfer medium. Feed ethylene and hydrogen into the second reactor, but do not feed fresh catalyst into the second reactor. Inert gases, nitrogen and isopentane make up the remaining gas composition in both the first and second FB-GPP reactor. Polymerization conditions for the first and second reactors are reported in Table A. In Table A, “HMW Rx” means the gas phase polymerization reaction that makes the HMW PE constituent in the first reactor, and “LMW Rx” means the gas phase polymerization reaction that makes the LMW PE constituent in the second reactor.

TABLE A
Reactor Conditions for Examples IE1-IE3

| | IE1 | | IE2 | | IE3 | |
|---|---|---|---|---|---|---|
| Reactor Operating | HMW | LMW | HMW | LMW | HMW | LMW |
| Conditions | Rx | Rx | Rx | Rx | Rx | Rx |
| Catalyst | sd-Cat-1 (slurry) | | sd-Cat-1 (Powder) | | sd-Cat-1 (Powder) | |
| Temperature (° C.) | 93 | 85 | 93 | 85 | 93 | 85 |
| Pressure (kPa) | 2413 | 2399 | 2057 | 2373 | 2061 | 2377 |
| C2 Partial Pressure | 689 | 1833 | 511 | 1720 | 483 | 1745 |
| (kPa) | | | | | | |
| H2/C2 Molar Ratio | 0.00034 | 0.0050 | 0.00036 | 0.0051 | 0.00037 | 0.0050 |
| C6/C2 Molar Ratio | 0.0031 | 0.0000 | 0.0023 | 0.0000 | 0.0000 | 0.0000 |
| Isopentane (mol %) | 9.8 | 5.0 | 9.9 | 5.0 | 10.0 | 5.1 |
| CA-300 feed rate | 2 | | 3 | | 3 | |
| (cc/hr) | | | | | | |
| Production rate | 17.3 | 15.3 | 13.4 | 13.9 | 12.7 | 12.6 |
| (kg/hr) | | | | | | |
| Bed Weight (kg) | 62 | 89 | 47 | 54 | 46 | 53 |
| Split (Wt %) | 53.2 | 46.8 | 49.1 | 50.9 | 50.3 | 49.7 |
| Catalyst feed rate* | 4.7 | | 6.0 | | 4.4 | |
| (g/hr) | | | | | | |

*dry solids basis

TABLE A
Reactor Conditions for Examples IE4-IE5

| | IE4 | | IE5 | |
|---|---|---|---|---|
| Reactor Operating | HMW | LMW | HMW | LMW |
| Conditions | Rx | Rx | Rx | Rx |
| Catalyst | XCAT ™ VP-100¹ | | XCAT ™ VP-100¹ | |
| Temperature (° C.) | 86 | 85 | 93 | 85 |
| Pressure (kPa) | 2397 | 2399 | 2398 | 2399 |
| C2 Partial Pressure | 553 | 1721 | 552 | 1721 |
| (kPa) | | | | |
| H2/C2 Molar Ratio | 0.00030 | 0.0030 | 0.00031 | 0.0030 |
| C6/C2 Molar Ratio | 0.0027 | 0.0000 | 0.0023 | 0.0000 |
| Isopentane (mol %) | 10.4 | 4.9 | 10.4 | 5.0 |
| CA-300 feed rate | 2 | | 2 | |
| (cc/hr) | | | | |
| Production rate | 22.1 | 16.0 | 20.5 | 15.2 |
| (kg/hr) | | | | |
| Bed Weight (kg) | 72 | 90 | 74 | 92 |
| Split (Wt %) | 57.9 | 42.1 | 57.3 | 42.7 |
| Catalyst feed rate* | 9.3 | | 10.0 | |
| (g/hr) | | | | |

*dry solids basis
¹Product of Univation Technologies, LLC, Houston, Texas, USA.

TABLE A
Reactor Conditions for Examples IE6 and CE1

| | IE6 | | CE1 | |
|---|---|---|---|---|
| Reactor Operating | HMW | LMW | HMW | LMW |
| Conditions | Rx | Rx | Rx | Rx |
| Catalyst | sd-Cat-1 (slurry) | | sd-Cat-1 (Powder) | |
| Temperature (° C.) | 85 | 85 | 93 | 85 |
| Pressure (kPa) | 2403 | 2391 | 2397 | 2544 |
| C2 Partial Pressure | 517 | 1844 | 530 | 1552 |
| (kPa) | | | | |
| H2/C2 Molar Ratio | 0.00032 | 0.0060 | 0.00039 | 0.0060 |
| C6/C2 Molar Ratio | 0.0011 | 0.0000 | 0.0022 | 0.0000 |
| Isopentane (mol %) | 9.0 | 5.0 | 10.1 | 5.0 |
| CA-300 feed rate | 3.5 | | 2.5 | |
| (cc/hr) | | | | |
| Production rate | 16.6 | 11.5 | 12.9 | 16.2 |
| (kg/hr) | | | | |
| Bed Weight (kg) | 55 | 80 | 40 | 69 |
| Split (Wt %) | 58.9% | 41.1% | 44.3% | 55.7% |
| Catalyst feed rate* | 2.0 | | 3.0 | |
| (g/hr) | | | | |

*dry solids basis

Formulating Examples with Additives.

Separately combine each example (IE1-IE6 and CE1) as granules with 1500 parts per million weight (ppmw) Antioxidant 1. Feed the combination to a continuous mixer (LCM-100 from Kobe Steel, Ltd.), which is closed coupled to a gear pump and equipped with a melt filtration device and underwater pelletizing system to separately produce strands that are cut into pellets of stabilized polyethylene blends.

### Testing and Properties.

Properties of the stabilized examples produced above are tested using the Test Methods listed below. In addition, the properties of the HMW PE constituent are measured using the Test Methods listed below on BHT-stabilized (2000 ppmw) samples of the granular resins directly from the first reactor. The results are shown in Table B. Table B also shows published properties for certain examples from WO2013040676A1.

TABLE B
Resin Properties

| | Overall Resin Properties | | | | | | | | |
|---|---|---|---|---|---|---|---|---|---|
| | Melt | Flow | | | | | | | |
| | Index | Index | | Molecular | | | Short- | | |
| | (I₂) | (I₂₁) | | Weight Profile | | | Chain | | HMW |
| | g/ | g/ | | (kg/mol) | | | Branch | ESCR | Content |
| | 10 | 10 | Density | | | MWD | branch/ | (F50) | “Split” |
| Ex | min | min | g/cm³ | Mₙ | M_{w} | (Mw/Mn) | 1000 C | hours | wt % |
| IE1 | 1.8 | 77 | 0.954 | 7.0 | 121 | 17.3 | 1.3 | 850 | 52% |
| IE2 | 1.9 | 80 | 0.954 | 6.6 | 100 | 15.2 | 1.1 | 1000+ | 49% |
| IE3 | 2.3 | 110 | 0.955 | 6.5 | 104 | 15.9 | 1.3 | 460 | 50% |
| IE4 | 2.4 | 71 | 0.953 | 11.3 | 93 | 8.2 | 1.2 | 140 | 59% |
| IE5 | 2.1 | 69 | 0.953 | 10.7 | 95 | 8.9 | 1.3 | 150 | 59% |
| IE6 | 3.1 | 204 | 0.958 | 6.2 | 92 | 15 | 1.71 | 213 | 44% |
| CE1 | 3.3 | 142 | 0.959 | 5.9 | 89 | 15 | 0.58 | 22 | 59% |
| Lit1³ | 1.7 | 103 | 0.952 | 10.6 | 86 | 8.2 | | 212 | 46% |
| Lit2³ | 1.5 | 82 | 0.952 | 13.3 | 88 | 6.6 | | 86 | 45% |
| Lit3³ | 1.8 | 99 | 0.953 | 9.7 | 85 | 8.7 | | 83 | 45% |
| Li⁴ | 2.1 | 113 | 0.953 | 11.1 | 81 | 7.2 | | 73 | 45% |

| | HMW Properties² | | | | | | | |
|---|---|---|---|---|---|---|---|---|
| | | Melt | Flow | | | | | |
| | | Index | Index | Molecular | | | Short- | |
| | | (I₂) | (I₂₁) | Weight Profile | | | chain | LMW |
| | | g/ | g/ | (kg/mol) | | | Branch | Comp. |
| | Density | 10 | 10 | | | MWD | branch/ | Density ¹ |
| Ex | g/cm³ | min | min | Mₙ | M_{w} | (Mw/Mn) | 1000 C | g/cm³ |
| IE1 | 0.93 | 0.28 | 4.7 | 62.4 | 201 | 3.2 | 2.5 | 0.982 |
| IE2 | 0.9305 | 0.31 | 5.3 | — | — | — | 2.1 | 0.978 |
| IE3 | 0.93 | 0.33 | 5.6 | 56.6 | 170 | 3 | 2.8 | 0.982 |
| IE4 | 0.933 | 0.49 | 8.3 | 54.7 | 145 | 2.6 | 2.1 | 0.982 |
| IE5 | 0.933 | 0.42 | 7.1 | 53.8 | 149 | 2.8 | 2.2 | 0.982 |
| IE6 | 0.933 | | 4.4 | 67.2 | 179.9 | 2.68 | 1.71 | 0.979 |
| CE1 | 0.937 | | 4.4 | 57.2 | 164.1 | 2.87 | 0.93 | 0.992 |
| Lit1³ | 0.9325 | 0.13 | | | 165.1 | <3.0 | 1.57 | 0.970 |
| Lit2³ | 0.9302 | 0.12 | | | 168.1 | <3.0 | 2.24 | 0.971 |
| Lit3³ | 0.9322 | 0.13 | | | 162.7 | <3.0 | 1.71 | 0.971 |
| Li⁴ | 0.9316 | 0.15 | | | 157.2 | <3.0 | 2.02 | 0.972 |

¹ Complementary Density.
²HMW Properties were measured from samples of HMW Component taken from outflow of first stage reactor without second stage reaction.
³Examples Lit1-Lit4 are Inventive Example 3, 4, 5, and 7, respectively, from WO2013040676A1.

### Test Methods

Unless otherwise noted, the values reported herein were determined according to the following test methods.

### Density

Samples that are measured for density are prepared according to ASTM D4703. Measurements are made within one hour of sample pressing using ASTM D792, Method B.

### Melt Index

Melt index, also referred to as I₂ or I_{2.16}, for ethylene-based polymers is determined according to ASTM D1238 at 190° C., 2.16 kg.

High load melt index or Flow Index, also referred to as I₂₁ or I_{21.6}, for ethylene-based polymers is determined according to ASTM D1238 at 190° C., 21.6 kg.

### Short-Chain Branching/Comonomer Content

The samples were prepared by adding ˜100 mg of sample to 3.25 g of 1,1,2,2-tetrachlorethane (TCE), with 12 wt % as TCE-d2, in a Norell 1001-7 10 mm NMR tube. The solvent contained 0.025 M Cr(AcAc)3 as a relaxation agent. (AcAc=acetyl acetone). Sample tubes were purged with N2, capped, and sealed with Teflon tape before heating and vortex mixing at 145° C. to achieve a homogeneous solution.

13C NMR was performed on a Bruker AVANCE 600 MHz spectrometer equipped with a 10 mm extended temperature cryoprobe. The data was acquired using a 7.8 second pulse repetition delay, 90-degree Flip angles, and inverse gated decoupling, with a sample temperature of 120° C. All measurements were made on non-spinning samples in locked mode. Samples were allowed to thermally equilibrate for seven minutes prior to data acquisition. The 13C NMR chemical shifts were internally referenced to the EEE triad at 30.0 ppm.

Content is determined as set out in ASTM 5017-17, Standard Test Method for Determination of Linear Low Density Polyethylene (LLDPE) Composition by Carbon-13 Nuclear Magnetic Resonance, ASTM International, West Conshohocken, PA, 2017, www.astm.org. Other useful publications include: ASTM D 5017-96; J. C. Randall et al., “NMR and Macromolecules” ACS Symposium series 247; J. C. Randall, Ed., Am. Chem. Soc., Washington, D.C., 1984, Ch. 9, and J. C. Randall in “Polymer Sequence Determination”, Academic Press, New York (1977).

### Gel Permeation Chromatography (GPC) Molecular Weight Determination

Polymer molecular weight is characterized by high temperature gel permeation chromatography (GPC). The chromatographic system consists of a Polymer Laboratories “GPC-220 high temperature” chromatograph, equipped with a Precision Detectors (Amherst, Mass.) 2-angle laser light scattering detector, Model 2040, and a 4-capillary differential viscometer detector, Model 210R, from Viscotek (Houston, Tex.). The 15° angle of the light scattering detector is used for calculation purposes.

Data collection is performed using PolymerChar (Valencia, Spain) GPC One Instrument Control. The system is equipped with an on-line solvent degas device from Polymer Laboratories. The carousel compartment and column compartment are operated at 150° C. The columns are four Polymer Laboratories “Mixed A” 20 micron columns, and one 20 um guard column. The polymer solutions are prepared in 1,2,4 trichlorobenzene (TCB). The samples are prepared at a concentration of 0.1 grams of polymer in 50 ml of solvent. The chromatographic solvent and the sample preparation solvent contain 200 ppm of butylated hydroxytoluene (BHT). Both solvent sources are nitrogen sparged. Polyethylene samples are stirred gently at 160° C. for 4 hours. The injection volume is 200 μl, and the flow rate is 1.0 ml/minute.

Calibration of the GPC column set is performed with 21 narrow molecular weight distribution polystyrene standards. The molecular weights of the standards range from 580 to 8,400,000, and are arranged in 6 “cocktail” mixtures, with at least a decade of separation between individual molecular weights. The polystyrene standard peak molecular weights are converted to polyethylene molecular weights using the following equation (as described in Williams and Ward, J. Polym. Sci., Polym. Let., 6, 621 (1968)):

M_{polyethylene}=A×(M_{polystyrene})^{B},

where M is the molecular weight, A has a value of 0.4316, and B is equal to 1.0.

A fifth order polynomial is used to fit the respective polyethylene-equivalent calibration points. The total plate count of the GPC column set is performed with Eicosane (prepared at 0.04 g in 50 milliliters of TCB, and dissolved for 20 minutes with gentle agitation.) The plate count and symmetry are measured on a 200 microliter injection according to the following equations:

$$PlateCount = 5.54 * {( \frac{RV at Peak Maximum}{Peak Width at 1 / 2 height} )}^{2}$$

where RV is the retention volume in milliliters, and the peak width is in milliliters.

$$Symmetry = \frac{( Rear Peak Width at \frac{1}{10} height ) - ( RV at Peak Maximum )}{( RV at Peak Maximum ) - ( Front Peak Width at \frac{1}{10} height )} ,$$

where RV is the retention volume in milliliters, and the peak width is in milliliters.

The calculations of Mₙ and Mw are based on GPC results using the RI detector are determined from the following equations:

$$\overline{Mn} = \frac{{\sum }^{i} {RI}_{i}}{{\sum }^{i} ( {RI}_{i} / {Mcalibration}_{i} )} , \\ \overline{Mw} = \frac{{\sum }^{i} ( {RI}_{i} * {Mcal}_{i} )}{{\sum }^{i} ( {RI}_{i} )} ,$$

In order to monitor the deviations over time, which may contain an elution component (caused by chromatographic changes) and a flow rate component (caused by pump changes), a late eluting narrow peak is generally used as a “marker peak”. A flow rate marker is therefore established based on decane flow marker dissolved in the eluting sample. This flow rate marker is used to linearly correct the flow rate for all samples by alignment of the decane peaks. Any changes in the time of the marker peak are then assumed to be related to a linear shift in both flow rate and chromatographic slope. The preferred column set is of 20 micron particle size and “mixed” porosity to adequately separate the highest molecular weight fractions appropriate to the claims. The plate count for the chromatographic system (based on eicosane as discussed previously) should be greater than 20,000, and symmetry should be between 1.00 and 1.12.

### Resin Environmental Stress Crack Resistance (ESCR)

The resin environmental stress crack resistance (ESCR) (F₅₀) is measured according to ASTM D-1693-01, Standard Test Method for Environmental Stress-Cracking of Ethylene Plastics, ASTM International, West Conshohocken, P A, 2001, www.astm.org, condition B at 50° C. using a 10% aqueous solution of Tergitol NP-9 or equivalent. The ESCR value is reported as F₅₀, the calculated 50 percent failure time from the probability graph.

1. A high density polyethylene composition comprising:
a) 40 to 65 weight percent of a higher molecular weight ethylene copolymer component having a flow index (I₂₁) in the range of 1 to 10 g/10 min and a density of from 0.920 to 0.935 g/cm³ and a molecular weight distribution (M_{w}/Mₙ) of less than 4.0, and
b) 35 to 60 weight percent of a lower molecular weight ethylene homopolymer or copolymer component having a complementary density (CD) of greater than 0.976 g/cm³ according to the following formula:
$$CD = \frac{LMW Component Weight Percent / 100}{( \frac{1}{Overall Density} ) - ( \frac{HMW Component Weight Percent / 100}{HMW Component Density} )}$$
wherein weight percentages are based on percentages of the combined weight of the higher molecular weight component and lower molecular weight polyethylene component only and wherein the high density polyethylene composition has overall:
i. a melt index (I₂) of less than or equal to 4.5 g/10 min, and
ii. a density from 0.950 to 0.962 g/cm³.

2. The polyethylene composition of claim 1, wherein the polyethylene composition has a molecular weight distribution (Mw/Mn) greater than 7.5.

3. The polyethylene composition of claim 1, wherein the polyethylene composition has a molecular weight distribution (M_{w}/Mₙ) of 14 to 20.

4. The polyethylene composition of claim 1, wherein the polyethylene composition has a density from 0.953 to 0.960 g/cm³.

5. The polyethylene composition of claim 1, wherein the polyethylene composition has a melt index (I₂) from 1.3 to 4.2 g/10 min.

6. The polyethylene composition of claim 1, wherein the polyethylene composition has a melt index (I₂) from 2.1 to 3.3 g/10 min.

7. The polyethylene composition of claim 1, wherein the higher molecular weight ethylene copolymer component makes up from 42 to 54 weight percent of the polyethylene composition, based on the combined weight of the higher molecular weight component and the lower molecular weight component.

8. The polyethylene composition of claim 1, wherein the higher molecular weight ethylene copolymer component has a molecular weight distribution (M_{w}/Mₙ) of from 2.3 to 3.6.

9. The polyethylene composition of claim 1, wherein the higher molecular weight ethylene copolymer component has a density from 0.928 to 0.935 g/cm³.

10. The polyethylene composition of claim 1, wherein the higher molecular weight ethylene copolymer component has a flow index (I₂₁) from 4 to 8 g/10 minutes.

11. The polyethylene composition of claim 1, wherein the complementary density of the lower molecular weight component is from 0.977 to 0.985 g/cm³.

12. The polyethylene composition of claim 1, wherein the environmental stress crack resistance (F₅₀) of the polyethylene composition satisfies the following formula:
$${F}_{50} \geq 400 hr - ( MI ) * 78 [ ( 10 - min * hr / g ) ]$$
wherein F₅₀ is the environmental stress crack resistance in hours, MI is the melt index (I₂) of the polyethylene composition in g/10 minutes, and the measurement is performed according to ASTM D-1693, condition B at 50° C., and using 10 percent Branched Octylphenoxy Poly (Ethyleneoxy) Ethanol and wherein F₅₀ is at least 100 hours.

13. The polyethylene composition of claim 1, wherein the polyethylene composition was polymerized using a hafnium-containing metallocene catalyst system.

14. A molded article formed from the polyethylene composition of claim 1.

15. The molded article of claim 14, wherein the molded article is a closure for a beverage bottle.
